(19) United States
(12) Patent Application Publication
(10) Pub. No.: US 2007/0278880 A1
(43) Pub. Date: Dec. 6, 2007

(54) Disk Apparatus

(76) Inventors: Shinichi Wada, Ehime (JP); Hiroshi Ikeno, Tottori (JP)

Correspondence Address: KRATZ, QUINTOS & HANSON, LLP, 1420 K Street, N.W., Suite 400, WASHINGTON, DC, 20005, US

(21) Appl. No.: 10/591,298

(22) PCT Filed: Oct. 14, 2004
(86) PCT No.: PCT/JP04/15544

§ 371 Date: May 31, 2007

(30) Foreign Application Priority Data
Mar. 5, 2004 (JP) 2004-62845

(51) Int. Cl. H02K 5/167

(52) U.S. Cl. 310/90

(57) ABSTRACT

A disk apparatus comprises a rotor frame 221 in which disk holding member is placed on a center of an upper surface of the rotor frame 221, a shaft 222 mounted on a center of the rotor frame 221, a bearing metal 231 which holds the shaft 222, a holder 232 which is disposed on an outer periphery of the bearing metal 231 and which holds the bearing metal 231, a stator 240 disposed on an outer periphery of the holder 232, a magnet 224 fixed to the rotor frame 221 at a location opposed to the stator 240, and a thrust cap 233 fixed to a center of a lower portion of the holder 232. An outer periphery of the lower portion of the holder 232 is swaged and fixed to a motor plate 234, and the shaft 222 is disposed between the disk holding member and the thrust cap 233.

### TECHNICAL FIELD

The present invention relates to a disk apparatus for recording or replaying into or from a disk-like recording medium such as a CD and a DVD, and more particularly, to a so-called slot-in type disk apparatus capable of directly inserting or discharging a disk from or to outside.

### BACKGROUND TECHNIQUE

As the slot-in type disk apparatus, there are roller type and arm type disk transfer methods (e.g., patent documents 1 and 2). In the transfer method of any of these types, it is necessary to provide a predetermined clearance between a turntable and a disk when the disk is to be transferred. In order to provide the clearance, a traverse is vertically moved or a clamper is vertically moved.

In order to reduce the thickness of such a slot-in type disk apparatus, it is effective to thin a spindle motor.

(Patent document 1) Japanese Patent Application Laid-open No. H7-220353

(Patent document 2) Japanese Patent Application Laid-open No. 2002-352498

In order to lower the height of the spindle motor, the length of a shaft which is a rotation shaft must be shortened, and if the shaft length is shortened, since a bearing metal length can not be secured sufficiently, a surface of the turntable rocks and its lifetime is reduced.

Hence, it is an object of the present invention to provide a disk apparatus in which a bearing metal length is sufficiently secured, the height of the spindle motor is reduced, thereby reducing the thickness and size of the disk apparatus without causing the surface rocking of the turntable and without shortening the lifetime.

### DISCLOSURE OF THE INVENTION

A first aspect of the present invention provides a disk apparatus comprising a rotor frame in which disk holding member is placed on a center of an upper surface of the rotor frame, a shaft mounted on a center of the rotor frame, a bearing metal which holds the shaft, a holder which is disposed on an outer periphery of the bearing metal and which holds the bearing metal, a stator disposed on an outer periphery of the holder, a magnet fixed to the rotor frame at a location opposed to the stator, and a thrust cap fixed to a center of a lower portion of the holder, in which an outer periphery of the lower portion of the holder is swaged and fixed to a motor plate, and the shaft is disposed between the disk holding member and the thrust cap, wherein the rotor frame at the location opposed to the bearing metal is projected toward the disk holding member, thereby forming a bearing metal space in a lower portion of a center of the rotor frame, and an upper end of the bearing metal is brought closer to the rotor frame.

With this aspect, since the upper end of the bearing metal can extend to the bearing metal space formed in the lower portion of the center of the rotor frame, the length of the bearing metal can be secured.

According to a second aspect of the invention, in the disk apparatus of the first aspect, a recess is formed in the thrust cap at a location opposed to the shaft.

With this aspect, the thrust cap is formed with the recess and the shaft can extend to the recess. Therefore, the boundary between the side surface and the end surface of the shaft can be disposed downward and the lower end of the bearing metal can extend, and the length of the bearing metal can be secured.

According to a third aspect of the invention, in the disk apparatus of the second aspect, a protrusion is formed on a center of a lower end surface of the shaft, and a protrusion projecting toward the shaft is formed on a center of the recess of the thrust cap at a location opposed to the shaft.

With this aspect, the contact resistance of the shaft lower end surface protrusion and the protrusion of the thrust cap with respect to the load in the thrust direction can be reduced.

According to a fourth aspect of the invention, in the disk apparatus of the second aspect, a lower end surface of the shaft is formed into a spherical shape, thereby forming the protrusion, and an upper surface of the recess of the thrust cap is formed into a spherical shape, thereby forming the protrusion.

With this aspect, the protrusions are formed into the spherical shapes. With this, the contact resistance with respect to the load in the thrust direction can be reduced.

According to a fifth aspect of the invention, in the disk apparatus of the second aspect, a lower end surface of the thrust cap by the recess has the same height as that of a lower end surface of the swaging portion of the thrust cap of the holder.

With this aspect, since the recess of the thrust cap is formed utilizing the swaging height, even if the recess is formed in the thrust cap, it is possible to prevent the height of the motor from being increased.

According to a sixth aspect of the invention, in the disk apparatus of the second aspect, a thrust sheet which is thinner than a recess amount of the thrust cap is provided between the thrust cap and the shaft.

With this aspect, the boundary of the side surface and the end surface of the shaft can be disposed downward due to the thin thrust sheet, the lower end of the bearing metal can extend. Further, the contact resistance with respect to the load in the thrust direction can be reduced.

According to a seventh aspect of the invention, in the disk apparatus of the second aspect, an upper surface of the recess of the thrust cap or a lower end surface of the shaft is coated with a fluorine-based lubricating paint or tungsten.

With this aspect, the contact resistance with respect to the thrust direction can be reduced by the coating of the fluorine-based lubricating paint or tungsten.

According to an eighth aspect of the invention, in the disk apparatus of the first aspect, a hole or a recess is formed in a motor plate at a location corresponding to a convex portion of an insulator of a coil constituting the stator.

With this aspect, it is possible to prevent the height of the motor from being increased by the insulator.

According to a ninth aspect of the invention, in the disk apparatus of the first aspect, a thickness of a projection of the rotor frame located above the bearing metal is made thinner than a basic thickness of the rotor frame by drawing operation or crushing operation.

With this aspect, since the upper end of the bearing metal can extend to the bearing metal space formed in the lower portion of the center of the rotor frame, the length of the bearing metal can be secured.

According to a tenth aspect of the invention, in the disk apparatus of the first aspect, a side of the motor plate located outside from an outer periphery of the rotor frame is projected toward the rotor frame.

According to a tenth aspect of the invention, in the disk apparatus of the first aspect, the motor plate is projected toward the rotor frame by drawing outside of the motor plate from an outer periphery of the rotor frame.

With this aspect, when the motor is fixed to a chassis or the like using a screw, the thickness of a head of the screw can be accommodated in the motor height, and the apparatus can be reduced in thickness.

According to an eleventh aspect of the invention, in the disk apparatus of the first aspect, the rotor frame is subjected to nitrogen processing.

With this aspect, the rotor frame is subjected to the nitrogen processing, the surface hardness is increased, the strength is enhanced by 10 to 20% and thus, the thickness of the rotor frame can be reduced, the metal length can be secured, and the apparatus can be reduced in thickness.

### BRIEF DESCRIPTION OF THE DRAWINGS

FIG. 1 is a sectional view of an essential portion of a spindle motor of a disk apparatus according to an embodiment of the present invention;

FIG. 2 is a plan view of an essential portion of the spindle motor of the disk apparatus;

FIG. 3 is a plan view of an essential portion of a base body of the disk apparatus of the embodiment;

FIG. 4 is a side sectional view of an essential portion of the disk apparatus; and

FIG. 5 is a side view of a sub-slider of the disk apparatus.

### BEST MODE FOR CARRYING OUT THE INVENTION

A disk apparatus according to an embodiment of the present invention will be explained below.

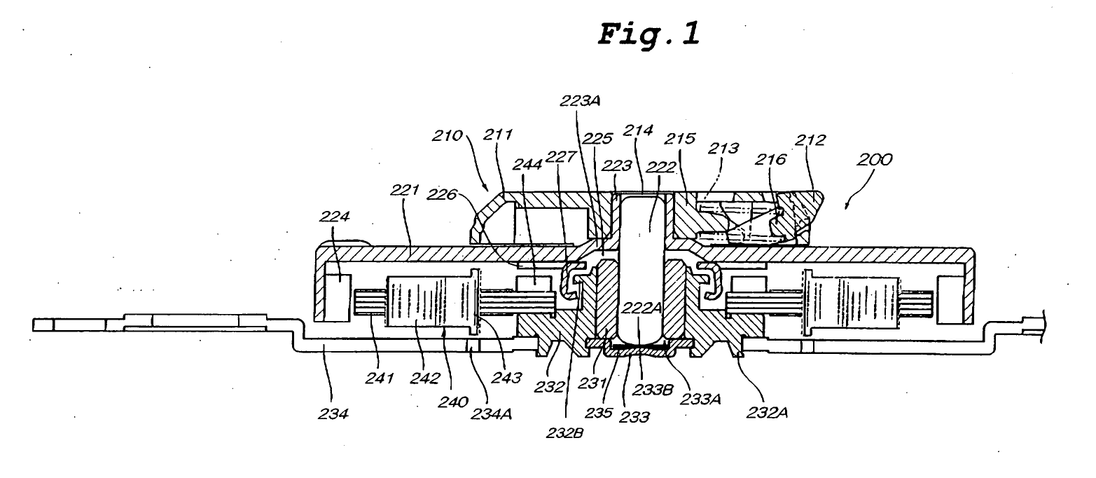

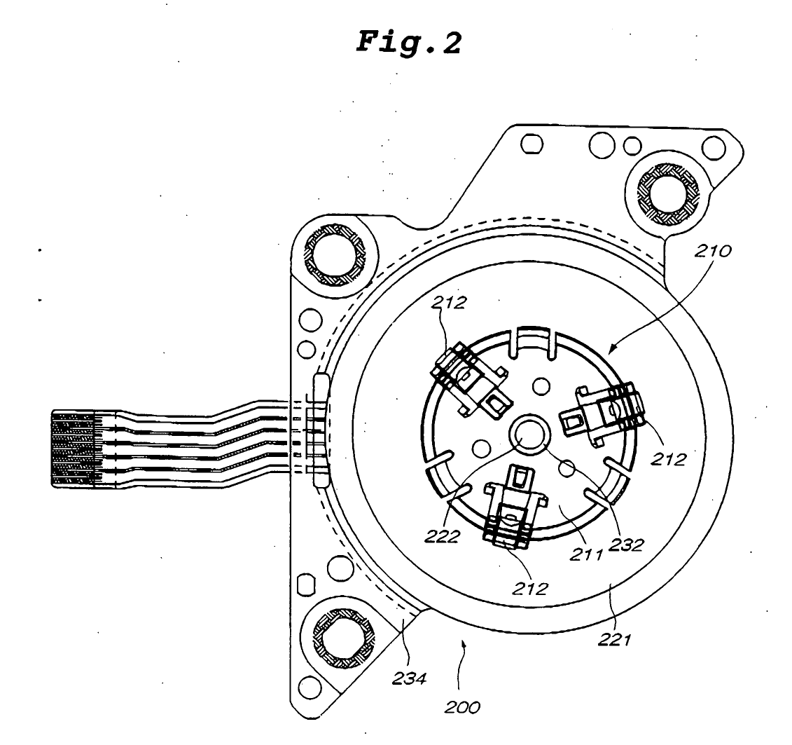

FIG. 1 is a sectional view of an essential portion of a spindle motor of the disk apparatus according to the embodiment of the invention. FIG. 2 is a plan view of an essential portion of the spindle motor of the disk apparatus.

The spindle motor 200 of the disk apparatus of the embodiment includes a rotor frame 221. A chuck member (disk holding member) 210 is placed on a center of an upper surface of the rotor frame 221. The chuck member 210 includes a hub body 211, a pawl 212 and a coil spring 213. The coil spring 213 has pawls 212 projecting from the hub body 211. The hub body 211 is formed into a dish shape by a disk-like upper surface and a side surface rising from an outer periphery of the upper surface. A hole 214 in which a shaft 222 is disposed is formed in a center of the upper surface of the hub body 211. Openings in which the pawls 212 are disposed are radially formed in the hub body 211. These openings are formed in a range extending from the outer periphery of the upper surface of the hub body 211 to its side surface. A back surface of the hub body 211 is provided with a ring-like rib forming a hole 214 and coil stoppers 215 projecting from an outer periphery of the rib. The coil stoppers 215 are radially formed toward a pawl openings. A coil stopper 216 against which the coil spring 213 abuts is disposed on an inner side of the pawls 212.

The rotor frame 221 is subjected by nitrogen processing. When the thickness of the rotor frame 221 is 0.5 mm or less, the effect for enhancing its strength caused by the nitrogen processing is exhibited. A cylindrical portion 223 having a predetermined length is formed on the center of the rotor frame 221. The shaft 222 is mounted on the cylindrical portion 223 through a projection 223A protecting toward the chuck member 210. The cylindrical portion 223 is fitted into the hole 214 of the chuck member 210. Therefore, the chuck member 210 and the shaft 222 rotate together with the rotor frame 221. The thickness of the cylindrical portion 223 of the rotor frame 221 and the thickness of the projection 223A provided on the outer periphery of the cylindrical portion 223 are formed thinner than the basic thickness of the rotor frame 221 by a drawing operation or a crushing operation.

The shaft 222 is rotatably held by a bearing metal 231. A lower end surface of the shaft 222 is formed into a spherical surface, thereby forming a protrusion 222A. A holder 232 is disposed on an outer periphery of the bearing metal 231. The bearing metal 231 is held by the holder 232. The projection 223A of the rotor frame 221 is located above the bearing metal 231. A stator 240 is disposed on an outer periphery of the holder 232. The holder 232 holds the stator 240. The stator 240 comprises a plurality of laminated cores 241, and coils 242 wound around the cores. An insulator 243 of the coil 242 projects outward than the outer periphery of the coil.

A magnet 224 is fixed to the rotor frame 221 at a position opposed to the stator 240.

A thrust cap 233 is fixed to a center of a lower portion of the holder 232. An outer periphery of the lower portion of the holder 232 is swaged and fixed to a motor plate 234.

One end of the shaft 222 is disposed in the vicinity of the upper surface of the chuck member 210, and the other end of the shaft 222 abuts against the upper surface of the thrust cap 233.

The cylindrical portion 223 of the rotor frame 221 and the outer periphery of the cylindrical portion 223, i.e., the projection 223A opposed to the bearing metal 231 project toward the chuck member 210. With this, a bearing metal space 225 is formed in a lower portion of the center of the rotor frame 221. The thickness of the projection 223A is set thinner than the basic thickness of the rotor frame 221. With this, the metal space 225 is widened. An upper end of the bearing metal 231 is close to the rotor frame 221. Therefore, since the upper end of the bearing metal 231 can extend toward the bearing metal space 225 formed in the lower portion of the center of the rotor frame 221, the length of the bearing metal 231 can be secured.

A recess 233A is formed in the center of the thrust cap 233, i.e., a portion of the thrust cap 233 opposed to the shaft 222. A spherical protrusion 233B is formed on the center of the recess 233A of the thrust cap 233. The protrusion 233B and the protrusion 222A of the shaft 222 are opposed to each other. The shaft 222 and the thrust cap 233 can be in point-contact with each other by bringing the protrusions 222A and 233B into abutment against each other. With this, the contact resistance with respect to a load in the thrust direction can be reduced. A thrust sheet 235 which is shallower than the thrust cap 233 is provided between the thrust cap 233 and the shaft 222. With this thrust sheet 235, the contact resistance with respect to the load in the thrust direction can be reduced. It is preferable that the upper surface of the recess 233A of the thrust cap 233 or the lower end surface of the shaft 222 is coated with fluorine-based lubricating paint or tungsten. With this coating, the contact resistance with respect to the load in the thrust direction can be reduced.

The lower end surface of the thrust cap 233 by the recess 233A has the same height as that of the lower end surface of a thrust cap swaging portion 232A of the holder 232. Since the recess 233A of the thrust cap 233 is formed utilizing the height of the thrust cap swaging portion 232A in this manner, even if the recess 233A of the thrust cap 233 is formed, it is possible to prevent the height of the motor from increasing.

A hole 234A is formed in the motor plate 234 at a portion thereof corresponding to a projection of the insulator 243. A recess may be provided instead of the hole 234A. If a recess or the hole 234A is provided, it is possible to prevent the height of the motor from being increased by the insulator 243. The motor plate 234 is projected toward the rotor frame 221 by drawing a side of the rotor frame 221 located on the outer side from the outer periphery of the rotor frame 221. Since the outside of the motor plate 234 projects toward the rotor frame 221 in this manner, when the motor is fixed to a chassis by a screw, the thickness of a head of the screw is accommodated within the motor height, and the apparatus can be reduced in thickness.

A magnet 244 is provided on an upper surface of each of the cores 241 of the stator 240. A metal plate 226 is provided on a lower surface of the rotor frame 221 opposed to the magnet 244. The magnet 244 and the metal plate 226 attract the rotor frame 221 toward the motor plate 234. A projection 232B is formed on an outer periphery of the upper end of the holder 232. An engaging portion 227 is provided on a lower surface of the rotor frame 221 opposed to the projection 232B. The projection 232B and the engaging portion 227 prevent the rotor frame 221 from being detached from the motor plate 234.

The disk apparatus to which the spindle motor of the embodiment is applied will be explained.

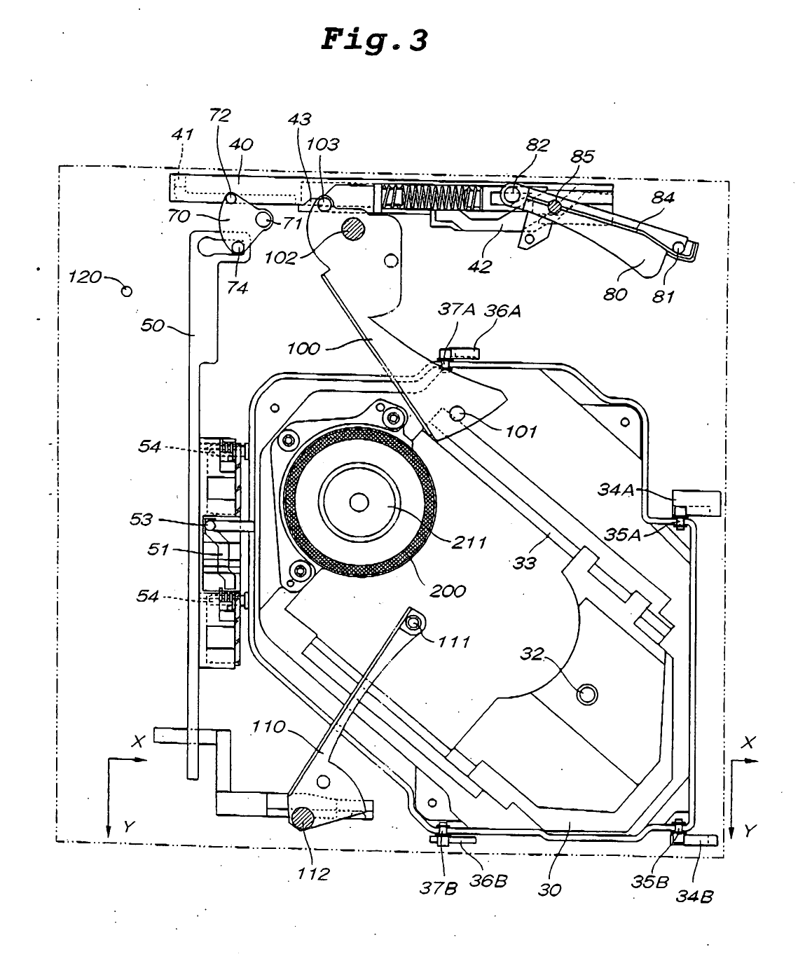

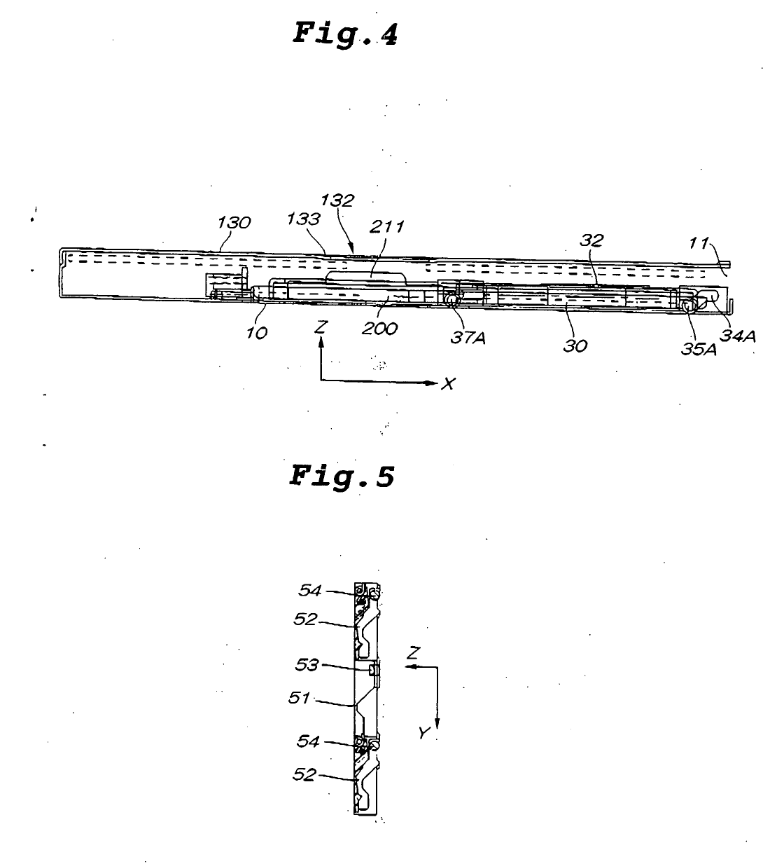

FIG. 3 is a plan view of an essential portion of a base body of the disk apparatus of the embodiment. FIG. 4 is a side sectional view of an essential portion of the disk apparatus. FIG. 5 is a side view of a sub-slider of the disk apparatus.

The disk apparatus of this embodiment includes a chassis outer sheath comprising a base body and a lid. A bezel is mounted on a front surface of the chassis outer sheath. The disk apparatus of this embodiment is a slot-in type disk apparatus in which a disk is directly inserted from a disk inserting opening formed in the bezel.

The disk apparatus of this embodiment includes a chassis outer sheath comprising a base body and a lid. A bezel is mounted on a front surface of the chassis outer sheath. The disk apparatus of this embodiment is a slot-in type disk apparatus in which a disk is directly inserted from a disk inserting opening formed in the bezel.

A disk inserting opening 11 into which a disk is directly inserted is formed in a front side of a base body 10. A traverse 30 is disposed in the base body 10.

The traverse 30 holds the spindle motor 200, a pickup 32, and drive means 33 for moving the pickup 32. A rotation shaft of the spindle motor 200 includes the hub body 211 for holding a disk. The spindle motor 200 is provided on one end of the traverse 30. The pickup 32 is disposed on the other end of the traverse 30 in a standby state or a chucking state. The pickup 32 can move from one end to the other end of the traverse 30. The drive means 33 includes a drive motor, rails for allowing the pickup 32 to slide, and a gear mechanism for transmitting a driving force of the drive motor to the pickup 32. The pair of rails are disposed on the opposite sides of the pickup 32 such as to connect the one end and the other end of the traverse 30.

In the traverse 30, the spindle motor 200 is located at a central portion of the base body 10, a reciprocating range of the pickup 32 is located closer to the disk inserting opening 11 than the spindle motor 200, and a reciprocating direction of the pickup 32 is different from an inserting direction of the disk. Here, an angle formed between the reciprocating direction of the pickup 32 and the inserting direction of the disk is 40 to 45°.

The traverse 30 is supported on the base body 10 by fixing cams 34A and 34B. It is preferable that the pair of fixing cams 34A and 34B are disposed closer to the pickup 32 than the spindle motor 200 and are disposed closer to the disk inserting opening 11 than the standby position of the pickup 32. In this embodiment, the fixing cam 34A is provided at a central portion in the vicinity of an inside of the disk inserting opening 11, and the fixing cam 34B is provided on the one end in the vicinity of the inside of the disk inserting opening 11. The fixing cams 34A and 34B comprise grooves of predetermined lengths extending in the inserting direction of the disk. The end of one end of the groove close to the disk inserting opening 11 is separated away from the base body 10 than the other end thereof by a first Z axis distance. Cam pins 35A and 35B provided on the traverse 30 slide in the grooves of the fixing cams 34A and 34B, thereby displacing the traverse 30 in the inserting/discharging direction (X axis direction) of the disk and displacing the traverse 30 in a direction (Z axis direction) in which the traverse 30 is brought close to and away from the base body 10.

A main slider 40 and a sub-slider 50 which move the traverse 30 will be explained next.

The main slider 40 and the sub-slider 50 are disposed sideway of the spindle motor 200. The main slider 40 is disposed in such a direction that one end thereof is close to a front surface of the base body 10 and the other end of the main slider 40 is close to a rear surface of the base body 10. The sub-slider 50 is disposed in such a direction that intersects with the main slider 40 at right angles.

A cam mechanism for displacing the traverse 30 comprises a slider cam mechanism 51 and a vertically moving cam mechanism 52. The cam mechanism is provided on the sub-slider 50. The slider cam mechanism 51 comprises a groove of a predetermined length extending in a moving direction of the sub-slider 50. This groove approaches the disk inserting opening 11 (X axis direction) in stages from its one end (closer to the main slider 40) toward the other end. The traverse 30 is provided with a slide pin 53. The slide pin 53 provided on the traverse 30 slides in the groove of the slider cam mechanism 51, thereby displacing the traverse 30 in the inserting/discharging direction (X axis direction) of the disk. The vertically moving cam mechanism 52 comprises a groove of a predetermined length extending in the moving direction of the sub-slider 50. A distance (Z axis distance) between the groove and the base body 10 is varied in stages from one end thereof (closer to the main slider 40) toward the other end. The vertically moving pin 54 provided on the traverse 30 slides in the groove of the vertically moving cam mechanism 52, thereby displacing the traverse 30 in a direction (Z axis direction) in which the traverse 30 is brought close to and away from the base body 10.

A loading motor (not shown) is disposed on one end of the main slider 40. A drive shaft of the loading motor and one end of the main slider 40 are connected to each other through a gear mechanism (not shown).

The main slider 40 can slide in a longitudinal direction (X axis direction) by driving the loading motor. The main slider 40 is connected to the sub-slider 50 through a cam lever 70.

The cam lever 70 includes a turning fulcrum 71, the cam lever 70 is engaged with a cam groove 41 provided in the main slider 40, and the cam lever 70 is engaged with a cam groove provided in the sub-slider 50 through a pin 74.

The cam lever 70 moves the sub-slider 50 in association with movement of the main slider 40, operates the slider cam mechanism 51 and the vertically moving cam mechanism 52 by the movement of the sub-slider 50, and displaces the traverse 30.

The traverse 30 is further supported on the base body 10 by fixing cams 36A and 36B also. It is preferable that the pair of fixing cams 36A and 36B are disposed between the fixing cams 34A and 34B and the sub-slider 50, and are disposed at intermediate positions between the fixing cams 34A and 34B and the sub-slider 50. The fixing cams 36A and 36B comprise grooves of predetermined lengths which are the same structures as those of the fixing cams 34A and 34B. Cam pins 37A and 37B provided on the traverse 30 slide in the fixing cams 36A and 36B, thereby displacing the traverse 30 in the inserting direction of the disk, and displacing the traverse 30 in a direction in which the traverse 30 is brought close to and away from the base body 10.

The above explained traverse 30, fixing cams 34A, 34B, 36A, and 36B, main slider 40, sub-slider 50, and loading motor are provided on the base body 10, and form a disk-inserting space between a lid 130 and these members.

Next, a guide member for supporting a disk and a lever member for operating the disk will be explained.

A first disk guide (not shown) of a predetermined length is provided on one end side of the base body 10 in the vicinity of the disk inserting opening 11. The first disk guide has a groove having a U-shaped cross section as viewed from a disk inserting direction. A disk is supported by this groove.

A pulling-in lever 80 is provided on the other end side of the base body 10 in the vicinity of the disk inserting opening 11. A movable side end of the pulling-in lever 80 includes a second disk guide 81. The second disk guide 81 comprises a cylindrical roller, and the second disk guide 81 is turnably provided on the movable side end of the pulling-in lever 80. A groove is formed in a roller outer periphery of the second disk guide 81, and the disk is supported by this groove.

The pulling-in lever 80 is disposed such that its movable side end is operated on the side of the disk inserting opening 11 than its fixed side end, and the fixed side end includes a turning fulcrum 82. A third disk guide 84 of a predetermined length is provided between the movable side end and the fixed side end of the pulling-in lever 80. The pulling-in lever 80 includes a pin 85. If the pin 85 slides in a cam groove 42 of the main slider 40, the pulling-in lever 80 is operated. That is, the pulling-in lever 80 is operated such that as the main slider 40 moves, the second disk guide 81 is brought close to and away from the spindle motor 200.

The base body 10 is provided with a discharging lever 100. A guide 101 is provided on a movable side end of one end of the discharging lever 100. The discharging lever 100 is provided at its other end with a turning fulcrum 102. The discharging lever 100 is operated in association with motion of the main slider 40 by a pin 103 and a cam groove 43.

A discharging lever 110 is provided on the base body 10 on the side opposed to the discharging lever 110. A guide 111 is provided on a movable side end of one end of the discharging lever 110. A turning fulcrum 112 is provided on the other end of the discharging lever 110. The discharging lever 110 moves in the same manner as that of the discharging lever 100.

The base body 10 is provided at its rear side with a fixing pin 120. The fixing pin 120 limits a position of a disk when the disk is loaded or chucked.

As shown in FIG. 4, the chassis outer sheath comprises the base body 10 and a lid 130. The lid 130 is provided at its central portion with an opening 132. The opening 132 is a circular opening having a radius greater than a center hole of the disk. Therefore, the opening 132 is larger than the hub body 211 of the spindle motor 200 which is fitted into the center hole of the disk.

The opening 132 is formed at its outer periphery with a narrowed portion 133 projecting toward the base body 10.

Although the disk chuck mechanism holds a disk on the side of the turntable in this embodiment, the disk clamp mechanism having a clamp may be used instead.

According to the present invention, a length of the bearing metal is sufficiently secured, the surface vibration of the turntable is not generated, the lifetime is not reduced, and the height of the spindle motor can be reduced.

### INDUSTRIAL APPLICABILITY

The disk apparatus of the embodiment is incorporated in a personal computer body having display means, input means and calculating means or is added later, and the disk apparatus is especially effective as a notebook personal computer in which the display means, the input means, the calculating means and the like are integrally provided.

1. A disk apparatus comprising a rotor frame in which disk holding member is placed on a center of an upper surface of said rotor frame, a shaft mounted on a center of said rotor frame, a bearing metal which holds said shaft, a holder which is disposed on an outer periphery of said bearing metal and which holds said bearing metal, a stator disposed on an outer periphery of said holder, a magnet fixed to said rotor frame at a location opposed to said stator, and a thrust cap fixed to a center of a lower portion of said holder, in which an outer periphery of the lower portion of said holder is swaged and fixed to a motor plate, and said shaft is disposed between said disk holding member and said thrust cap, wherein
said rotor frame at the location opposed to said bearing metal is projected toward said disk holding member, thereby forming a bearing metal space in a lower portion of a center of said rotor frame, and an upper end of said bearing metal is brought closer to said rotor frame.

2. The disk apparatus according to claim 1, wherein a recess is formed in said thrust cap at a location opposed to said shaft.

3. The disk apparatus according to claim 2, wherein a protrusion is formed on a center of a lower end surface of said shaft, and a protrusion projecting toward said shaft is formed on a center of the recess of said thrust cap at a location opposed to said shaft.

4. The disk apparatus according to claim 2, wherein a lower end surface of said shaft is formed into a spherical shape, thereby forming said protrusion, and an upper surface of the recess of said thrust cap is formed into a spherical shape, thereby forming said protrusion.

5. The disk apparatus according to claim 2, wherein a lower end surface of said thrust cap by said recess has the same height as that of a lower end surface of the swaging portion of the thrust cap of said holder.

6. The disk apparatus according to claim 2, wherein a thrust sheet which is thinner than a recess amount of said thrust cap is provided between said thrust cap and said shaft.

7. The disk apparatus according to claim 2, wherein an upper surface of the recess of said thrust cap or a lower end surface of said shaft is coated with a fluorine-based lubricating paint or tungsten.

8. The disk apparatus according to claim 1, wherein a hole or a recess is formed in a motor plate at a location corresponding to a convex portion of an insulator of a coil constituting said stator.

9. The disk apparatus according to claim 1, wherein a thickness of a projection of said rotor frame located above said bearing metal is made thinner than a basic thickness of said rotor frame by drawing operation or crushing operation.

10. The disk apparatus according to claim 1, wherein a side of said motor plate located outside from an outer periphery of said rotor frame is projected toward said rotor frame.

11. The disk apparatus according to claim 1, wherein said motor plate is projected toward said rotor frame by drawing outside of said motor plate from an outer periphery of said rotor frame.

12. The disk apparatus according to claim 1, wherein said rotor frame is subjected to nitrogen processing.
